(19) United States
(12) Patent Application Publication
(10) Pub. No.: US 2012/0155555 A1
(43) Pub. Date: Jun. 21, 2012

(54) VIDEO ENCODING APPARATUS AND METHOD FOR CONTROLLING THE SAME

(75) Inventors: Kyoung Seon SHIN, Daejeon (KR); Nak Woong EUM, Daejeon (KR)

(73) Assignee: ELECTRONICS AND TELECOMMUNICATIONS RESEARCH INSTITUTE, Daejeon (KR)

(21) Appl. No.: 13/285,036

(22) Filed: Oct. 31, 2011

(30) Foreign Application Priority Data
Dec. 15, 2010 (KR) 10-2010-0128662

(51) Int. Cl. H04N 7/26

(52) U.S. Cl. 375/240.26; 375/E07.2

(57) ABSTRACT

A video encoding apparatus includes: a video preprocessor configured to receive video data; a video encoder configured to encode an output signal of the video preprocessor; a host controller configured to control operations of the video preprocessor and the video encoder; and an operating mode controlling circuit configured to output an encoding control signal to the video encoder to change a preprocessing operation once receiving a control parameter and an operation command from the host controller during the operation of the video encoder.

### CROSS-REFERENCE TO RELATED APPLICATIONS

The present application claims priority to Korean patent application number 10-2010-0128662, filed on Dec. 15, 2010, which is incorporated by reference in its entirety.

### BACKGROUND OF THE INVENTION

The present invention relates to a video encoding apparatus and a method for controlling the same, and more particularly, to a video encoding apparatus for changing an operating mode while a video encoder operates in real-time and a method for controlling the same.

A system such as a Digital Video Recorder (DVR) or a mobile terminal adopting a video encoder consists of a camera, a video preprocessor, a video encoder, and a host controller, so that video data inputted from a camera terminal are converted into stream data that are several ten to several hundred times compressed in a video encoder terminal.

Recently, according to various demands of a system adopting a video encoder, real-time video compression of high quality is a basic demand and, also required are controls such as a change of a screen size during a real-time operation, a change of image quality, a change of a Group Of Pictures (GOP) period, and a forced insertion of an Instantaneous Decoder Refresh (IDR) frame.

Especially, in the case of a high-performance digital surveillance system, since it is important to store real-time videos, there should be no frame loss during the above controlling operations and the minimum operation delay is required.

### SUMMARY OF THE INVENTION

Embodiments of the present invention are directed to a controlling method for changing an operating mode while a video encoder operates in real-time.

Embodiments of the present invention are also directed to an apparatus for controlling a video encoder to have no initialization operation during a real-time operation while an operation that a host system requires is delivered to the video encoder, no stream interruption, no frame loss, and minimum operation delay.

In one embodiment, a video encoding apparatus includes: a video preprocessor configured to receive video data; a video encoder configured to encode an output signal of the video preprocessor; a host controller configured to control operations of the video preprocessor and the video encoder; and an operating mode controlling circuit configured to output an encoding control signal to the video encoder to change a preprocessing operation once receiving a control parameter and an operation command from the host controller during the operation of the video encoder.

The operating mode controlling circuit may output an encoding control signal according to the control parameter and the operation command to the video encoder in synchronization with a vertical sync signal.

In the operating mode controlling circuit, the maximum delay time until the encoding control signal is outputted after the control parameter and the operation command are received may be a time corresponding to one frame interval.

The operating mode controlling circuit may perform one of Instantaneous Decoder Refresh (IDR) middle insertion, a Group Of Pictures (GOP) period change, a Quantization Parameter (QP) change, and a change of parameter for frame unit encode control in the video encoder.

The operating mode controlling circuit may output a preprocessing control signal according to the control parameter and the operation command to the vide preprocessor in synchronization with a vertical sync signal.

In the operating mode controlling circuit, the maximum delay time until outputting the preprocessing control signal to the video preprocessor and outputting a corresponding encoding control signal to an encoder after receiving the control parameter and the operation command may be a time corresponding to two frame intervals.

A resolution or a frame rate may be changed in the video preprocessor and the video encoder by the operating mode controlling circuit.

In another embodiment, a method of controlling video encoding includes: receiving by an operating mode controlling circuit a control parameter and an operation command from a host controller; outputting by the operating mode controlling circuit an encoding control signal according to the control parameter and the operation command in synchronization with a vertical sync signal; and encoding by a video encoder a signal outputted from a video preprocessor according to the encoding control signal.

### BRIEF DESCRIPTION OF THE DRAWINGS

FIG. 1 illustrates a structure according to one embodiment of a system adopting a video encoder.

FIG. 2 illustrates a method of changing an operating mode while a video encoder operates according to one embodiment of the present invention.

FIG. 3 illustrates a video encode system structure including an operating mode controlling circuit according to one embodiment of the present invention.

FIG. 4 illustrates a configuration of an operating mode controlling circuit according to one embodiment of the present invention.

FIG. 5 illustrates a state machine executed in an operating mode controlling circuit according to one embodiment of the present invention.

### DESCRIPTION OF SPECIFIC EMBODIMENTS

Hereinafter, a video encoding apparatus and a method for controlling the same in accordance with the present invention will be described in detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Also, though terms like a first and a second are used to describe various members, components, regions, layers, and/or portions in various embodiments of the present invention, the members, components, regions, layers, and/or portions are not limited to these terms.

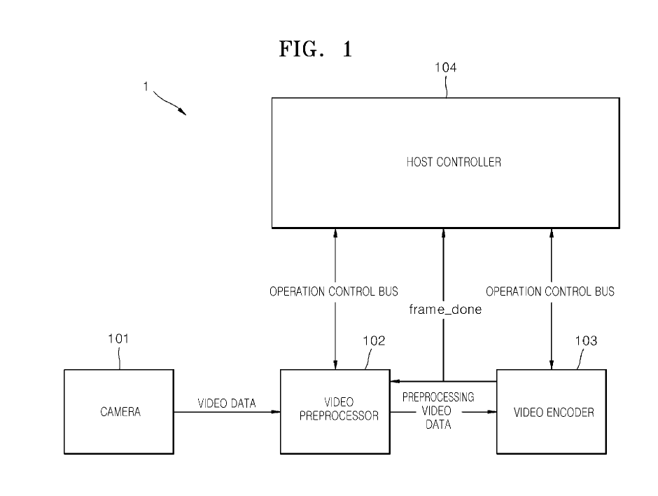

FIG. 1 illustrates a structure according to one embodiment of a system adopting a video encoder.

A camera 101 may deliver video data to a video preprocessor 102. The video preprocessor 102 may preprocess the video data and then may deliver them to a video encoder 103. The video encoder 103 may deliver a signal frame_done to a host controller 104 and the video preprocessor 102. The host controller 104 may control the video preprocessor 102 and the video encoder 103 through an operation control bus and also may control initialization, parameter setting, encoding execution, status check, stream control, and parameter change during execution.

In the video encoder system according to one embodiment of the present invention, an embodiment related to a method of changing an operating mode during an encoding operation will be described as follows.

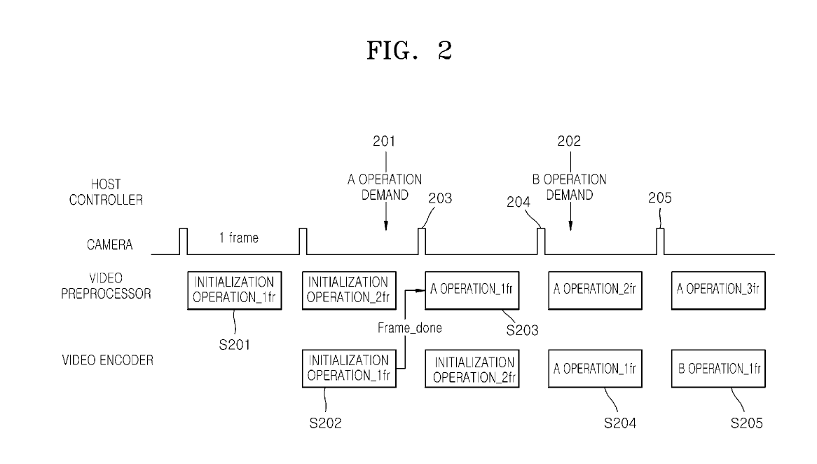

As shown in FIG. 2, when video data for each frame outputted from the camera 101 are stored or are necessary for another purpose, data are processed through the video preprocessor 102 at the point 201 and then are encoded by the video encoder 103 after one frame in operation S202. The host controller 104 may change a currently-processing A operation at arbitrary points 201 and 202 according to a surrounding environment. For example, in the case of a surveillance system adopting an H.264 encoder, a change of an operating mode shown in Table 1 may be required during real-time encoding. Table 1 represents a change of an operating mode in the case of the H.264.

TABLE 1

| | | | | Encoding |
|---|---|---|---|---|
| Operating | | Video | | operation |
| mode | Host controller | preprocessor | Video encoder | reflecting point |
| Resolution | 1. Async | 2. @ new Vsync | 3. @ new Vsync | After maximum |
| change | Request | -> output with | -> I-fr with | 2fr |
| | -> new size | new size | new size | |
| | | -> input with | -> SPS, PPS | |
| | | new size | | |
| Frame rate | 1. Async | 2. @ new Vsync | 3.. @ new Vsync | After maximum |
| change | Request | -> output as | -> encoding | 2fr |
| | -> new fps | new fps | with new fps | |
| | | -> input as new | | |
| | | fps | | |
| IDR middle | 1. Async | Same as | 2. @ new Vsync | After maximum |
| insertion or | Request | previous frame | -> I-fr with | 1fr |
| GOP period | -> new period | operation | new period | |
| change | | | -> SPS, PPS | |
| QP change or | 1. Async | Same as | 2. @ new Vsync | After maximum |
| encoder | Request | previous frame | -> apply | 1fr |
| parameter | -> new QP | operation | new QP | |
| change | (encoded) | | -> new | |
| | -> new | | parameter | |
| | parameter | | | |

In relation to a resolution change, if there is no movement in surveillance space, high resolution is changed into low resolution, so that an amount of stream may be reduced to effectively use storage space. As another example, when data of a surveillance target are compressed and stored in high quality with the same resolution, high-quality stream may be obtained by changing a Quantization Parameter (QP) of the video encoder. The important point is that in the case of a surveillance system, a real-time continuous operation needs to be performed without frame loss or stream interruption during the operation changing process.

FIG. 2 illustrates a method of changing an operating mode while a video encoder operates according to one embodiment of the present invention.

Referring to FIG. 2, a mode changing process during an encoding operation will be described in more detail.

In FIG. 2, when an A operation is required at the point 201, after a video preprocessing operation is changed in operation S203, a video encoding operation is changed in operation S204. At this point, the delay time may allow the maximum two frames. As an example of an operating mode of the A operation, resolution may be changed or a frame rate may be changed.

During the A operation required at the point 201, the host controller 104 writes a video preprocessing parameter corresponding to an operating mode and an encoder parameter in a host parameter register of the operating mode controlling circuit through a host operation control bus and then may additionally write a command RESOLUTION_cmd in a host command resister.

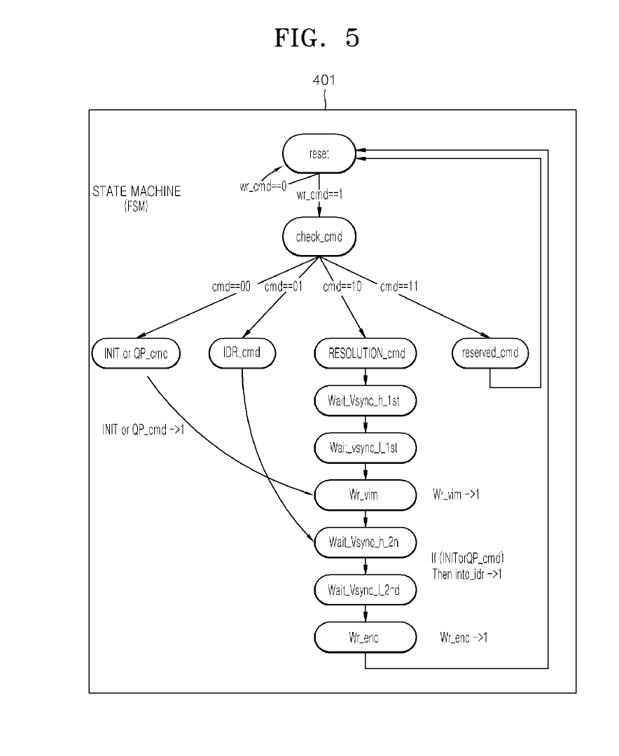

A state machine built-in an operating mode controlling circuit interprets the command RESOLUTION_cmd according to an embodiment of a state machine of FIG. 5 and delivers a parameter for video preprocessing in a first signal Vsync at the point 203, generated firstly after the A operation required at the point 201, to a video preprocessing parameter register to allow the video preprocessor 102 to perform the A operation (A operation_{—}1fr). Then, the state machine delivers a video encoder parameter in the second Vsync signal at the point 204 to an encoder parameter register to allow a video encoder to perform the A operation (A operation_{—}1fr).

In FIG. 2, when a B operation is required at the point 202, only an operation of the video encoder 103 may be changed without an operation change of the video preprocessor 102. At this point, the maximum value of allowed delay time may be a time corresponding to one frame. Examples of an operating mode of the B operation may include Instantaneous Decoder Refresh (IDR) middle insertion, a Group Of Pictures (GOP) period change, QP change, or parameter change for frame unit encoder control.

At the B operation required at the point 202, the host controller 104 writes an encode parameter corresponding to an operating mode in a host parameter resistor of an operating mode controlling circuit through a host operation control bus and then may additionally write IDR_cmd or a command INITorQP_cmd in a host command resistor.

A state machine built-in an operating mode controlling circuit interprets the IDR_cmd or the INITorQP_cmd according to an embodiment of the state machine of FIG. 5 and delivers a video encode parameter in a Vsync signal at the point 205, generated firstly after the B operation required at the point 202, to an encode parameter register to allow the video encoder to perform the B operation (B operation_{—}1fr) in operation S205.

Although the INITorQP_cmd and the IDR_cmd are similar to each other, as a command shared when an initialization operation is required, on receiving a video preprocessing parameter in the host controller 104, a processing process Wr_vim for delivering it to a terminal of the video preprocessor 102 may be additionally added.

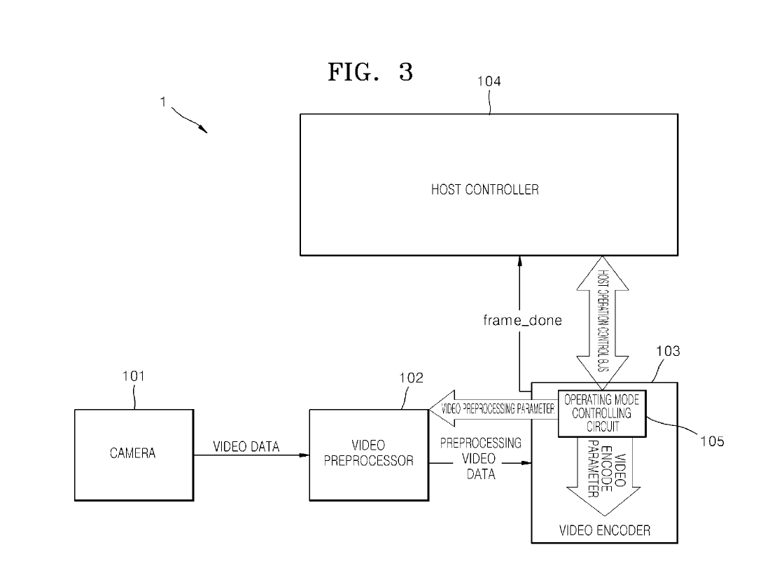

FIG. 3 illustrates a video encode system structure including an operating mode controlling circuit according to one embodiment of the present invention.

The camera 101 may deliver video data to the video preprocessor 102. The video preprocessor 102 preprocesses the video data and deliver them to the video encoder 103. The video encoder 103 may deliver a signal frame_done to the host controller 104 and may include an operating mode controlling circuit 105. The host controller 104 may control the operating mode controlling circuit 105 through an operation control bus and may perform controls such as initialization, parameter setting, encoder execution, status check, stream control, and a parameter change during execution. The operating mode controlling circuit 105 may deliver a video encode parameter to the video encoder 103, and may deliver a video preprocess parameter to the video preprocessor 102.

Unlike those shown in FIG. 3, the operating mode controlling circuit 105 may be provided separated from the video encoder 103.

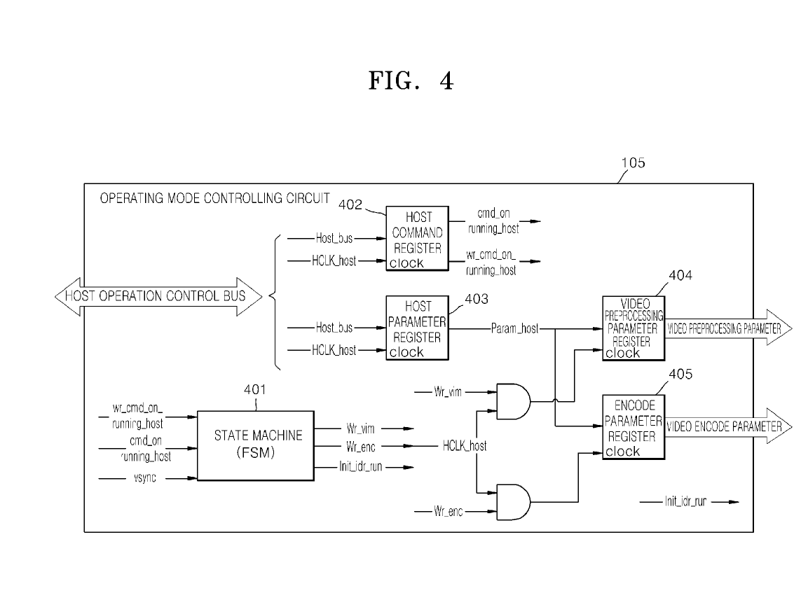

FIG. 4 illustrates a configuration of an operating mode controlling circuit according to one embodiment of the present invention.

FIG. 5 illustrates a state machine executed in an operating mode controlling circuit according to one embodiment of the present invention.

Referring to FIG. 4, the operating mode controlling circuit 105 includes a state machine 401, a host command register 402, a host parameter register 403, a video preprocessing parameter register 404, and a video encode parameter register 405.

The state machine 401 reads a command from the host command register 402 and uses it to generate an appropriate time point for delivering a parameter stored in the host parameter register 403 to the video encoder 103 or the video preprocessor 102.

The host command register 402 is connected to an operation control bus so that a command defined for each operation to be changed may be delivered.

The host parameter register 403 is connected to an operation control bus so that a parameter for causing an operation change of the video preprocessor 102 or the video encoder 103 may be delivered.

The video preprocessor parameter register 404 may be used for storing a parameter that is to be delivered to the video preprocessor 102 according to a control of the state machine 401.

The video encode parameter register 405 may be used for storing a parameter to be delivered to the video encoder 103.

At this point, the operation control bus (a host bus) may be used for receiving a parameter and a command from the host controller 104 to connect to the external.

The host command register 402 and the host parameter register 403 may receive a control signal from the host controller 104 through an operation control bus. At this point, they may receive a clock HCLK_host and data Host_bus of the host controller 104 through an operation control bus. The host command register 402 may output signals cmd_on_running_host and wr_cmd_on_running_host and the host parameter register 403 may output a signal Param_host.

The state machine 401 receives the signals cmd_on_running_host and wr_cmd_on_running_host and a vertical sync signal vsync and outputs signals Wr_vim, Wr_end and Init_idr_run. One embodiment of the state machine 401 is shown in FIG. 5.

The vertical sync signal vsync is generated in a video preprocessor and is used for generating a parameter delivery signal in the state machine 401.

The video preprocessing parameter register 404 and the video encode parameter register 405 receive a combination of signals Param_host, Wr_vim, HCLK_host, and Wr_enc and deliver a video preprocess parameter and a video encode parameter to the video preprocessor 102 and the video encoder 103, respectively.

Hereinafter, a video encoding apparatus according to one embodiment of the present invention will be described with reference to FIGS. 1 through 5.

The video encoding apparatus 1 includes a video preprocessor 102 for receiving video data, a video encoder 103 for encoding an output signal of the video preprocessor 102, a host controller 104 for controlling an operation of the video preprocessor 102 and the video encoder 103, and an operating mode controlling circuit 105 for mediating the video preprocessor 102 and the host controller 104 and mediating the video encoder 103 and the host controller 104. At this point, the operating mode controlling circuit 105 is not synchronized with an operation of the video encoder 103 and is configured to receive a control parameter and an operation command from the host controller 104 at an arbitrary point.

Here, the “mediating” means that the operating mode controlling circuit 105 receives a control parameter and an operation command from the host controller 104 to output an encoding control signal for controlling the video encoder 103 thereto, or the operating mode controlling circuit 105 receives a control parameter and an operation command from the host controller 104 to output a preprocessing control signal for controlling the video preprocessor thereto. Moreover, the encoding control signal may conceptually include the above-mentioned video preprocessing parameter and the preprocessing control single may conceptually include the above-mentioned video encode parameter (refer to FIG. 3).

The operating mode controlling circuit 105 may be configured to output an encoding control signal according to a control parameter and an operation command to the video encoder 103 in synchronization with a vertical sync signal. At this point, the operating mode controlling circuit 105 does not change an operation of the video preprocessor 102 and changes an operation of the video encoder 103, and the maximum delay time until an encoding control signal is outputted after the receiving of the control parameter and the operation command may be a time corresponding to a first frame interval of FIG. 2. At this point, one of IDR middle insertion, GOP period change, QP change, and parameter change for frame unit encoder control is performed in the video encoder 103 by the operating mode controlling circuit 105. Here, the vertical sync signal may mean a signal vsync inputted in the state machine 401 of FIG. 4. According to an embodiment, the signal vsync may be a signal occurring a boundary timing between image frames outputted from the camera 101 or the timing after a predetermined time from the boundary.

The operating mode controlling circuit 105 may be configured to synchronize a preprocessing control signal according to a control parameter and an operation command with a vertical sync signal to output the synchronized preprocessing control signal to the video preprocessor 102. At this point, the operating mode controlling circuit 105 is configured to change an operation of the encoder 103 after the changing of an operation of the video preprocessor 102 and the maximum delay time until a preprocessing control signal is outputted to the video preprocessor 102 and a corresponding encoding control signal is outputted to an encoder after the receiving of the control parameter and the operation command is a time corresponding to the second frame interval of FIG. 2. At this point, a resolution or frame rate may be changed in the video preprocessor 102 and the video encoder 103 by the operating mode controlling circuit 105.

Hereinafter, a video encoding method according to another embodiment of the present invention will be described with reference to FIGS. 1 through 4.

This method related to an encoding method in a video encoding apparatus 1 including a video preprocessor 102, a video encoder 103, an operating mode controlling circuit 105, and a host controller 104 includes receiving by the operating mode controlling circuit 105 a control parameter and an operation command from the host controller 104 without being synchronized with an operation of the video encoder 103, outputting by the operating mode controlling circuit an encoding control signal according to the control parameter and the operation command after being synchronized with a vertical sync signal, encoding by the video encoder 103 a signal outputted from the video preprocessor 102 according to an encoding control signal.

It is apparent that the video encoding method according to this embodiment selectively includes the features described in the embodiment related to the video encoding apparatus 1.

The camera 101 is used as an example of a device supplying an image signal to the video preprocessor 102 but the present invention is not limited thereto. Additionally, it is apparent that the video encoding apparatus according to the above descriptions of the present invention may not include the video preprocessor 102. If the video encoding apparatus does not include the video preprocessor 102, it may directly receive preprocessed video signals.

According to a configuration of the present invention, an operation changing demand in a host system during an encoding operation is possible with the minimum operation delay without encoder initialization, so that a continuous operation is possible without stream interruption during the middle of an operation or inputted video frame loss.

A technique of the present invention may be easily applied to a system such as a digital surveillance system, which requires no frame loss or no stream interruption during an encode operation control according to an environment change.

According to the present invention, after initialization, if necessary, a host controller may compress video data without frame loss or stream interruption during an operation changing process, with respect to A operation or B operation demand occurring without being synchronized with an encode operation at an arbitrary timing.

While the present invention has been particularly shown and described with reference to exemplary embodiments thereof, it will be understood by those of ordinary skill in the art that various changes in form and details may be made therein without departing from the spirit and scope of the present invention as defined by the following claims. Hitherto, the best mode was disclosed in the drawings and specification. While specific terms were used, they were not used to limit the meaning or the scope of the present invention described in Claims, but merely used to explain the present invention. Accordingly, a person having ordinary skill in the art will understand from the above that various modifications and other equivalent embodiments are also possible. Hence, the real protective scope of the present invention shall be determined by the technical scope of the accompanying Claims.

While this invention has been particularly shown and described with reference to preferred embodiments thereof, it will be understood by those skilled in the art that various changes in form and details may be made therein without departing from the spirit and scope of the invention as defined by the appended claims.

While the present invention has been described with respect to the specific embodiments, it will be apparent to those skilled in the art that various changes and modifications may be made without departing from the spirit and scope of the invention as defined in the following claims.

What is claimed is:

1. A video encoding apparatus comprising:
a video preprocessor configured to receive video data;
a video encoder configured to encode an output signal of the video preprocessor;
a host controller configured to control operations of the video preprocessor and the video encoder; and
an operating mode controlling circuit configured to output an encoding control signal to the video encoder to change a preprocessing operation once receiving a control parameter and an operation command from the host controller during the operation of the video encoder.

2. The video encoding apparatus of claim 1, wherein the operating mode controlling circuit outputs an encoding control signal according to the control parameter and the operation command to the video encoder in synchronization with a vertical sync signal.

3. The video encoding apparatus of claim 2, wherein in the operating mode controlling circuit, the maximum delay time until the encoding control signal is outputted after the control parameter and the operation command are received is a time corresponding to one frame interval.

4. The video encoding apparatus of claim 3, wherein the operating mode controlling circuit performs one of Instantaneous Decoder Refresh (IDR) middle insertion, a Group Of Pictures (GOP) period change, a Quantization Parameter (QP) change, and a change of parameter for frame unit encode control in the video encoder.

5. The video encoding apparatus of claim 2, wherein the operating mode controlling circuit outputs a preprocessing control signal according to the control parameter and the operation command to the vide preprocessor in synchronization with a vertical sync signal.

6. The video encoding apparatus of claim 5, wherein in the operating mode controlling circuit, the maximum delay time until outputting the preprocessing control signal to the video preprocessor and outputting a corresponding encoding control signal to an encoder after receiving the control parameter and the operation command is a time corresponding to two frame intervals.

7. The video encoding apparatus of claim 6, wherein a resolution or a frame rate is changed in the video preprocessor and the video encoder by the operating mode controlling circuit.

8. A method of controlling video encoding, the method comprising:
receiving by an operating mode controlling circuit a control parameter and an operation command from a host controller;
outputting by the operating mode controlling circuit an encoding control signal according to the control parameter and the operation command in synchronization with a vertical sync signal; and
encoding by a video encoder a signal outputted from a video preprocessor according to the encoding control signal.
